(19) United States
(12) Patent Application Publication
(10) Pub. No.: US 2025/0346239 A1
(43) Pub. Date: Nov. 13, 2025

(54) SYSTEM AND METHOD OF MONITORING, DETECTING, ESTIMATING AND ADJUSTING THE TIME SYNCHRONIZATION BETWEEN AN AUTOMATED VEHICLE AND A CENTRAL SERVER

(71) Applicant: Ford Global Technologies, LLC, Dearborn, MI (US)

(72) Inventors: Krishna Bandi, Novi, MI (US); Mario Anthony Santillo, Canton, MI (US); Meghna Menon, Ypsilanti, MI (US); Kalpak Kalvit, Milpitas, CA (US)

(21) Appl. No.: 19/179,506

(22) Filed: Apr. 15, 2025

Related U.S. Application Data
(60) Provisional application No. 63/635,037, filed on Apr. 17, 2024.

(51) Int. Cl. B60W 50/00; B60W 60/00; H04L 7/00

(52) U.S. Cl. CPC B60W 50/00; B60W 60/001; H04L 7/0008; B60W 2050/0083; B60W 2556/45; B60W 2556/50

(57) ABSTRACT

A method for synchronizing time between a central server and an automated vehicle (AV) includes exchanging a series of time synchronization (TS) messages and generating a set of time offsets between a pair of TS messages among the series of TS messages. The method further includes changing a system time of the AV using a time drift estimate defined by a set of time assessment models being a function of at least one of a plurality of time inputs or the set of layer time offset values, and controlling the AV using the system time and one or more marshalling instructions providing drive commands from the central server.

### CROSS-REFERENCE

This application claims the benefit of U.S. provisional application Ser. No. 63/635,037 filed Apr. 17, 2024, the disclosure of which is hereby incorporated in its entirety by reference herein.

### TECHNICAL FIELD

The present disclosure relates to a system and/or method for synchronizing time for marshalling automated vehicles.

### BACKGROUND

The statements in this section merely provide background information related to the present disclosure and may not constitute prior art.

Automated vehicles (AV) are configured to autonomously drive without the need for a human operator. Generally, an AV is provided a destination and using defined algorithms, the AV autonomously drives to the destination using the travel route.

In some applications, the AV can also be controlled by an external system that transmits drive commands to the AV to marshal the AV through an area. In a non-limiting example, the society of automotive engineers (SAE) issued a series of guidelines under SAE J3292 for supporting automated marshalling of vehicles in varies applications, such as but not limited to, manufacturing plants, depots, parking lots, and/or garages.

### SUMMARY

In one aspect, the present disclosure is directed to a method for synchronizing time between a central server and an automated vehicle (AV). The method includes obtaining a plurality of time inputs employable to synchronize clock of the AV, and exchanging a series of time synchronization (TS) messages, where each TS message is defined by a plurality of layers including at least two of an application layer, a transport layer, a security layer, or radio link layer. The method further includes generating a set of time offsets between a pair of TS messages among the series of TS messages, the set of time offsets defined for at least one layer among the plurality of layers for the pair of TS messages. The method further includes changing a system time of the AV using a time drift estimate defined by a set of time assessment models being a function of at least one the plurality of time inputs and the set of layer time offset values, and controlling the AV using the system time and one or more marshalling instructions providing drive commands from the central server.

In another aspect, the present disclosure is directed to a vehicle system for an autonomous vehicle (AV) being marshalled in by a central server. The vehicle system includes one or more computing devices configured to: obtain a plurality of time inputs employable to synchronize the AV with the central server, exchange a series of time synchronization (TS) messages with the central server, each TS message defined by a plurality of layers including at least two of an application layer, a transport layer, a security layer, or radio link layer, generate a set of time offsets between a pair of TS messages among the series of TS messages, the set of time offsets defined for at least one layer among the plurality of layers for the pair of TS messages, change a system time of the AV using a time drift estimate defined by a set of time assessment models being a function of at least one the plurality of time inputs and the set of layer time offset values, and control the AV to perform a drive command using the system time in response to receiving a marshalling message having the drive command from the central server.

In yet another aspect, the present disclosure is directed to a system for autonomously controlling an autonomous vehicle (AV). The system includes an infrastructure server associated with a facility and including one or more computing devices. The one or more computing devices is configured to: obtain a plurality of time inputs employable to synchronize the AV with the infrastructure server, exchange a series of time synchronization (TS) messages with the AV, each TS message defined by a plurality of layers including at least two of an application layer, a transport layer, a security layer, or radio link layer, generate a set of time offsets between a pair of TS messages among the series of TS messages, the set of time offsets defined for at least one layer among the plurality of layers for the pair of TS messages, transmit a messaging including a command to change a system of the AV to an updated system time that is determined using a time drift estimate calculated using a set of time assessment models that are a function of at least one the plurality of time inputs and the set of layer time offset values, and transmit one or more marshalling instructions having one or more drive commands to the AV to control movement of the AV based on the updated system time.

### BRIEF DESCRIPTION OF THE DRAWINGS

In order that the disclosure may be well understood, there will now be described various forms thereof, given by way of example, reference being made to the accompanying drawings, in which:

FIG. 1 illustrates a plurality of automated vehicles and an automated vehicle marshalling central server (AVM CS) for marshalling the automated vehicles in accordance with the present disclosure;

FIG. 2 is a block diagram of an automated vehicle and the AVM CS in accordance with the present disclosure;

FIG. 3 is a flowchart of a time synchronization routine performed by a clock synchronization module; and

FIG. 4 is a flow diagram of a time synchronization message exchange between an AV and AVM CS.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. The figures are not necessarily to scale; some features may be exaggerated or minimized to show details of particular components. It should be understood that throughout the drawings, corresponding reference numerals indicate like or corresponding parts and features.

When marshalling an AV through an area, a system clock of the AV and of an automated vehicle marshalling central server (AVM CS) should be synchronized. For example, a time reference for the AV and AVM CS may comply to coordinated universal time (UTC) and a reference clock is to be accurate within accuracy of 1-msec of the UTC reference for the data elements of messages transmitted between the AV and AVM CS, where a timestamp reference is used in the message in the end-to-end architecture of an automated vehicle marshalling (AVM) system. Along with a timestamp, the messages exchanged also include a timestamp confidence that provides details about a time confidence at which the timestamp is generated.

In a non-limiting example, an AVM system may be employed to move AVs through end-of-line testing with the use of an overhead vision system coupled with the AVM CS for routing and motion control. Providing routing and motion control information may require robust time synchronization between the AVM CS and the AVs to efficiently move the AVs through the space without interfering with each other and/or objects, and/or without delays in cycle time.

One method for controlling AVs includes a trajectory control method based on time. If the AV or AVM CS is not aware of the times they are operating; it may cause interference between AVs or with the environment.

In one form, the present disclosure is directed to a system and/or method for monitoring, estimating, and adjusting a timestamp and a time confidence of the AV and/or AVM CS using a multi-layered approach that analyzes time based input data from external sources and from messages exchanged. This provides consistent time synchronization of AVs performing low and high speed automation features especially when time synchronization signals from external sources (e.g., global navigation satellite system (GNSS)) may degrade.

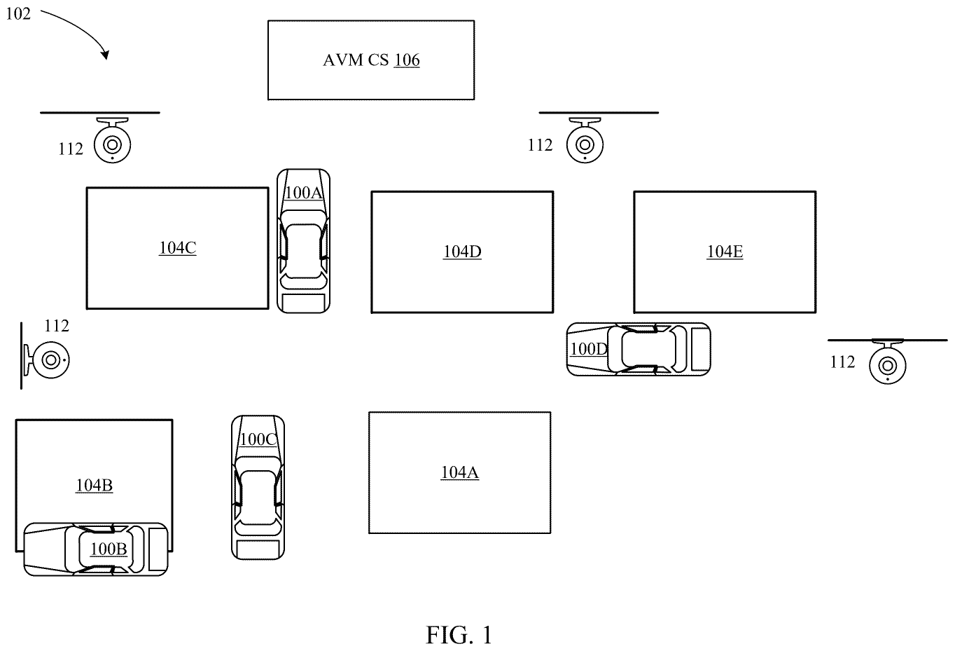

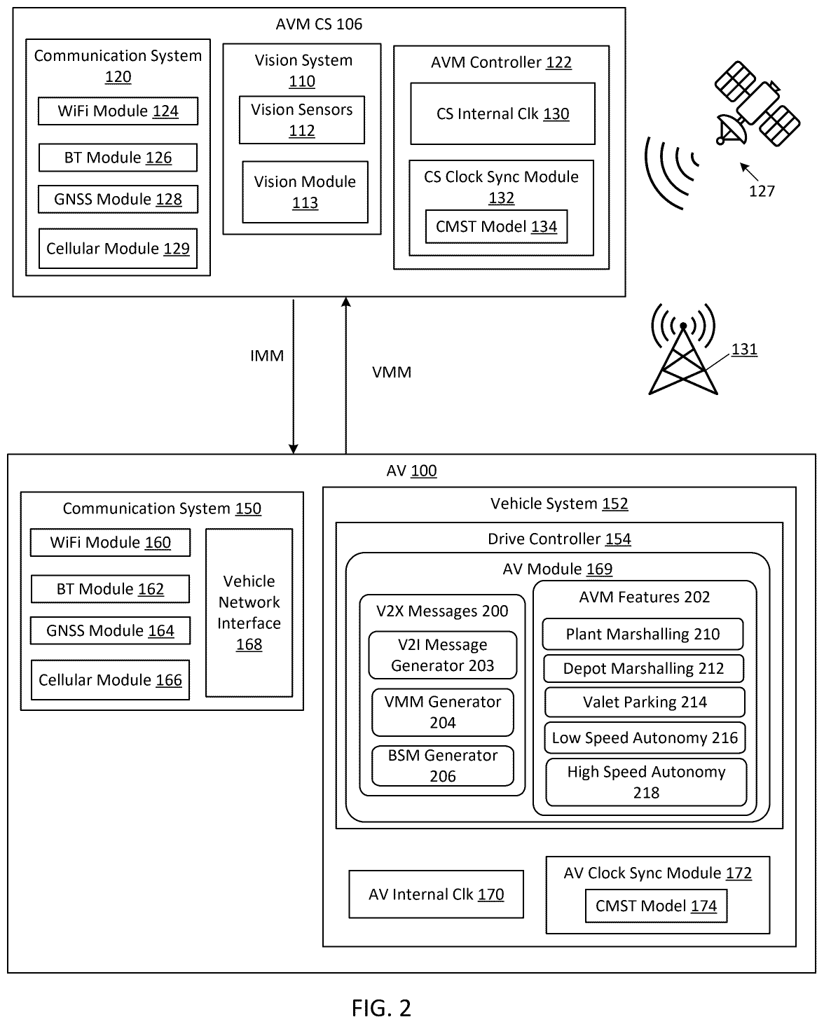

Referring to FIGS. 1 and 2, in a non-limiting example, autonomous vehicles 100A, 100B, 100C, 100D (collectively “autonomous vehicles 100”) are provided in a facility 102 in which the vehicles 100 are undergoing various system processes, such as calibration, software configuration, and/or testing. In one form, the autonomous vehicles 100 drive to various stations 104A, 104B, 104C, 104D, and 104E (collectively “stations 104”) under the control of an automated vehicle marshal central server (AVM CS) 106. That is, the autonomous vehicles 100, as automated vehicles (AVs), drive in the facility based on drive commands from the AVM CS 106, which tracks the location and orientation of the vehicle 100 using a vision system 110 (FIG. 2) that may be part of the AVM CS 106.

In the following, the autonomous vehicles 100 are referred to as automated vehicles (AV) 100. While the AVs 100 are illustrated as four wheel passenger vehicles, the present disclosure may be applicable to other types of AVs 100, such as but not limited to automatic guided vehicles, vehicles having one or more wheels, vehicles having a track moved by wheels, among other vehicles that can be autonomously controlled.

In one form, the vision system 110 includes a plurality of vision sensors 112 (e.g., cameras) that capture images of various areas of the facility 102, where the images are then processed by a vision module 113 to recognize, for example, the AVs 100, among other features in the facility 102.

In addition to the vision system 110, the AVM CS 106 also includes a communication system 120 and an AVM controller 122.

In one form, the communication system 120 is configured to support wireless and/or wired communication with, for example, the visions sensors 112, the AVs 100, among other devices and/or controllers in the facility 102. In one form, the communication system 120 is configured to establish wireless communication using any suitable wireless communication protocol. In a non-limiting example, the communication system 120 includes a WiFi module 124 configured to communicate using WiFi protocol, a Bluetooth® (BT) module 126 configured to communicate using BT protocol, a GNSS module 128 configured to obtain and process GNSS signal from one or more satellites 127, and a cellular module 129 configurated to communicate using one or more cellular protocols and a network of cellular towers 131.

The AVM controller 122 is configured to control the marshalling of one or more AVs 100 in the facility 102. As part of the marshalling control, the AVM controller 122 is configured to include a central server (CS) internal clock 130, which may also be provided as system clock of the AVM CS 106, and a CS clock synchronization module 132 having a connected marshalling system timer (CMST) model 136. As detailed herein, the CS clock synchronization (sync) module 132 is configured to monitor and adjust the time of the CS internal clock (Clk) 130 to provide accurate time synchronization with, for example, the AVs 100 for accurate marshalling of the AVs 100.

In one form, the AV 100 is configured to include a communication system 150 and a vehicle system 150 having a drive controller 154 for controlling drive operation of the AV 100.

The communication system 150 is configured to support wired and wireless communication with external devices or systems using various suitable techniques and/or wireless protocols. In a non-limiting example and like the communication system 120 of the AVM CS 106, the communication system 150 includes a WiFi module 160, a BT module 162, a GNSS module 164, and a cellular module 166. The communication system 150 further includes a vehicle network interface 168 (e.g., a gateway module) configured to connect to one or more vehicle communication network (e.g., controlled area network (CAN) and/or local interconnect network (LIN)) to communicate with other systems and/or controllers in the AV 100, such as but not limited to the vehicle system 152.

In one form, the drive controller 154 is configured to autonomously drive the AV 100 by controlling a drive system (not shown) of the AV 100. The drive controller 154 controls the AV 100 to a desired destination using, for example, drive control algorithms stored and executed by the drive controller 154 and/or using drive commands from the AVM CS 106. In some implementations, the drive controller 154 includes an AV module 169 supporting vehicle-to-everything (V2X) messages 200 and AVM features 202. In a non-limiting example, the V2X messages 200 includes vehicle-to-infrastructure (V2I) message generator 203, vehicle marshalling message (VMM) generator 204, and basic safety message (BSM) generator 206. The AVM features include different marshalling programs for the AV 100, such as, but not limited to: plant marshalling 210, depot marshalling 212, valet parking 214, low speed autonomy 216, and high speed autonomy 218.

Like the AVM CS 106, the vehicle system 152 includes an internal clock (AV internal Clk) 170 that is the system clock of the AV 100 and an AV clock synchronization (sync) module 172. The AV clock synchronization module 172 includes a CMST model 174 that operates in a similar manner as the CMST model 134 to provide accurate time synchronization with, for example, the AVM CS 106 for accurate marshalling.

In one form, the AVM controller 122 of the AVM CS 106 is configured to communicate with the AVs 100 using infrastructure marshalling messages (IMMs) wirelessly transmitted using the communication system 120. The vehicle system 152 of the AV 100 is configured to communicate with the AVM CS 106 using vehicle marshalling messages (VMM) that are wirelessly transmitted using the AV communication system 150.

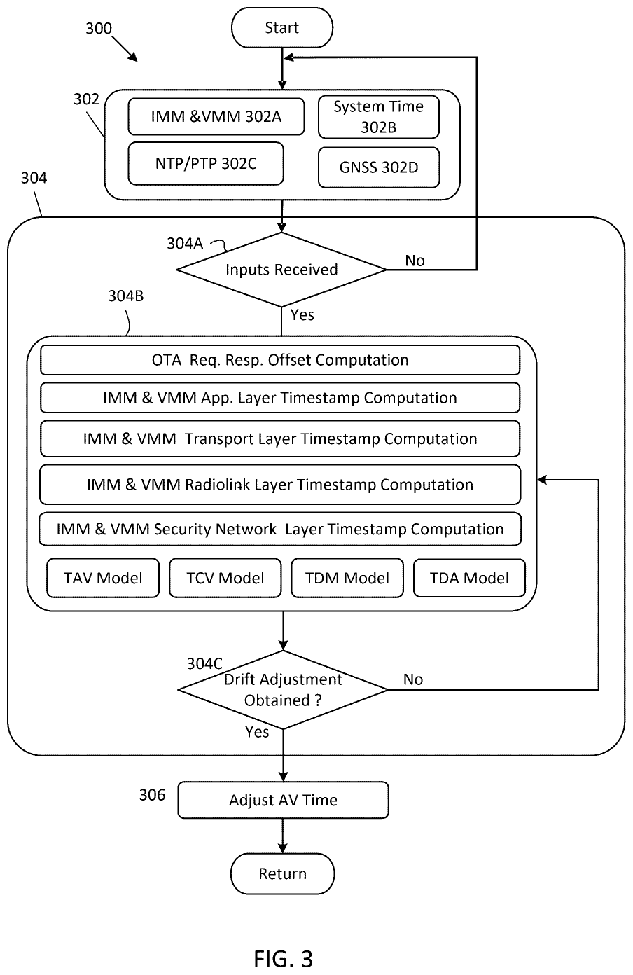

Referring to FIG. 3, an example time synchronization routine 300 performed by CS clock sync module 132 and the AV clock sync module 172 (collectively “CLK sync modules 132, 172) is provided.

At operation 302, the CLK sync modules 132, 172) obtains inputs employed for time synchronization. In a non-limiting example, Table 1 provides a list of inputs that may be received, and the type of information provided from the inputs. From among the inputs, the GNSS, internal computer clock, the NTP/PTP, and/or marshalling messages (VMM and/or IMM) may be referred to as time inputs employable to synchronize clocks of the AV 100. FIG. 3 illustrates example inputs including IMM &VMM 302A; system time 302B; NTP/PTP 302C, and GNSS 302D, but the inputs should not be limited to these examples and may include any combination or all of the inputs in table 1.

TABLE 1
Time Synchronization Inputs

| Inputs | Message Info |
|---|---|
| GNSS | gnss_fix |
| | number_of_satellites |
| | gnss_time |
| | gnss_tdop |
| | gnss_time_confidence |
| | semi_major_axis_accuracy |
| | semi_minor_axis_accuracy |
| Internal Computer Clock | Time (e.g., SysTime) and confidence (e.g., SystTimeConf) from |
| | internal clock |
| Network Time Protocol | ntp/ptp_clients_source |
| (NTP) | ntp/ptp_clock_drift |
| Precision Time Protocol | ntp/ptp_stratum |
| (PTP) | ntp/ptp_time |
| | ntp/ptp_wireless_offset |
| | ntp/ptp_time_confidence |
| Infrastructure Marshalling | IMM sent to AV for non-time sync activity. |
| Messages (IMM) | Data includes: |
| | Application layer time stamp (IMMAppLayTS) |
| | Application layer confidence level (IMMAppLayConf) |
| | Transport layer time stamp (IMMTransLayTS) |
| | Security layer time stamp (IMMSecLayTS) |
| | Radio Link Layer time stamp (IMMRadLayTS) |
| Vehicle Marshaling | VMM sent to AVM CS for non-time sync activity. |
| Message (VMM) | Data includes: |
| | Application layer time stamp (VMMAppLayTS) |
| | Application layer confidence level (VMMAppLayConf) |
| | Transport layer time stamp (VMMTransLayTS) |
| | Security layer time stamp (VMMSecLayTS) |
| | Radio Link Layer time stamp (VMMRadLayTS) |
| Defined Time Sync | Time related information captured during time synchronization |
| Messages | message exchange. |
| | Time a VMM time synchronization request is transmitted |
| | to the AVM CS from the AV (TSVMMReqTrnsmtTime) |
| | Time the VMM time synchronization request is received |
| | by the AVM CS from the AV |
| | (TSVMMReqReceiveTime) |
| | Time it takes the AVM CS to process the time |
| | synchronization request, (CSProcTime) |
| | Time a response to the time synchronization request is |
| | transmitted to the AV from the AVM CS |
| | (TSVMMRspnTrnmtTime) |
| | Time the response to the time synchronization request is |
| | received by the AV (TSVMMRspnReceiveTime) |

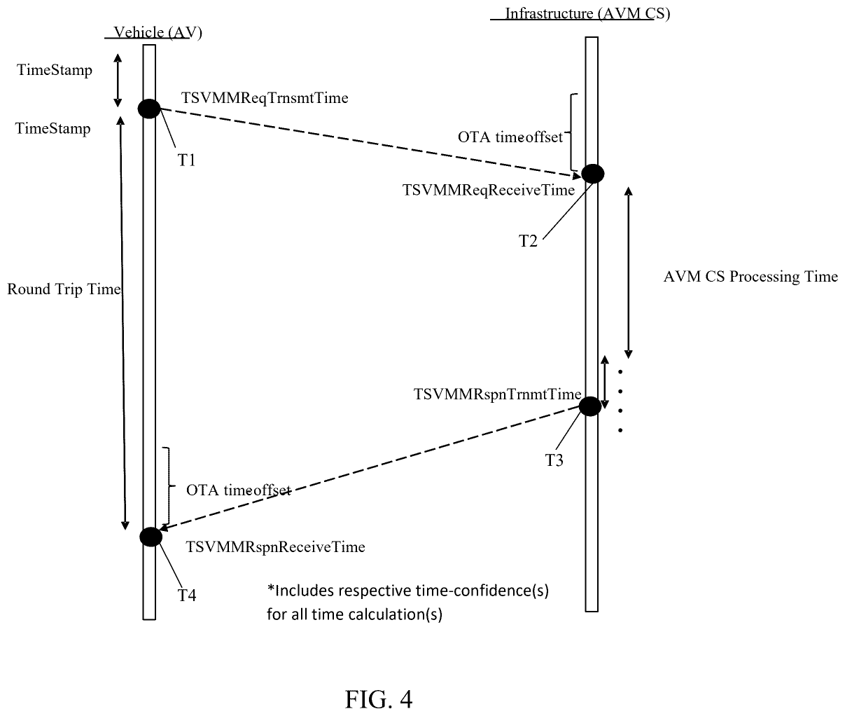

As part of the inputs, the CLK sync modules 132, 172 are configured to perform a defined time synchronization message exchange. Referring to FIG. 4, the AV 100 transmits a time synchronization request as a VMM to the AVM CS 106 at time T1 (e.g., TSVMMReqTrnsmtTime =T1). Like all marshalling messages, the request includes an application layer, a transport time, a security layer, and radio-link layer, where each layer includes a timestamp.

The AVM CS 106 receives the request at time T2 (e.g., TSVMMReqReceiveTime=T2. The AVM CS 106 processes the request received at time T2, and generates a time synchronization response to the AV 100 and transmits the response at time T3 (e.g., TSVMMRspnTrnmtTime=T3). The AV 100 receives the response at time T4 (e.g., TSVMMRspnReceiveTime=T4).

While FIG. 4 illustrates the time synchronization messages originating from the AV 100, a similar exchange may originate from the AVM CS 106.

Using the timestamp information from the messages exchanged, the CLK sync modules 132, 172 may determine time related information regarding the transmission and receipt of messages. In a non-limiting example, an over-the-air (OTA) time offset provides how long it take a message to arrive to a recipient after being transmitted, and is provided as a difference between the receipt time and the transmit time (e.g., T2-T1 or T4-T3).

In another example, the CLK sync modules 132, 172 further determine the time it takes the AV 100 to receive the response after transmitting the request, which is referred to as a round trip time and is determined as a difference between the receipt time of the response and the transmit time of the request (e.g., T4-T1). These and other time based analysis is performed by the CMST models 134, 174 for monitoring the time offset, detecting a drift in the timestamp, and if applicable, adjusting the time of the system clock.

With continuing reference to FIG. 3, the CMST models 134, 174 may perform the steps of operation 304 to adjust time of the AV 100. At operation 304A, the CMST models 134, 174 determines if the inputs are received to estimate a timestamp accuracy.

At operation 304B, the CMST model 134, 174 calculates offsets related to timestamps provided at the application layer, processing and round-trip-time using the VMM and/or IMM. In a non-limiting example, the offset includes: an over the air (OTA) request application layer time offset (OTAReqOffsetAppLayer) provided in equation 1; OTA response application layer time offset (OTARspnOffsetAppLayer) provided in equation 2; an AVM CS 106 processing time (CSProcTime) provided in equation 3; and a round trip time for the AV 100 for the time synchronization message request (RndTrpTimeOnVehAppLayer) provided in equation 4. In the equations “conf” is the confidence level for the time information provided, which maybe a different value for each data (e.g., the confidence value for TSVMMReqReceiveTime may be different from the confidence value for STSVMMReqTrnsmtTime). The offsets of equations 1, 2, 3, and 4 may generally be referred to as OTA request (req.) and response (resp) Offsets, and characterizes the application layer

$$OTAReqOffsetAppLayer = TSVMMReqReceiveTime + conf - TSVMMReqTrnsmtTime + conf \qquad Equation 1$$

$$OTARspnOffsetAppLayer = TSVMMRspnReceiveTime + conf - TSVMMRspnTrnmtTime + conf \qquad Equation 2$$

$$CSProcTime = TSVMMRspnTrnmtTime + conf - TSVMMReqReceiveTime + conf \qquad Equation 3$$

$$RndTrpTimeOnVehAppLayer = TSVMMRspnReceiveTime + conf - TSVMMReqTrnsmtTime + conf \qquad Equation 4$$

The CMST model 134, 174 further calculates the offset of one or more layers of the VMM and IMM. In one form, each VMM and IMM include an application layer, a transport layer, a security layer, and a radio link layer. Each layer includes a timestamp that can be used to determine a layer offset. In a non-limiting example, the CMST model 134, 174 calculates an AVM transport offset (AVMOffsetTrnprtLay), an AVM security timestamp (AVMOffsetSecLay), and an AVM radio link offset (AVMOffsetRadLay) using equations 5, 6, and 7, respectively. While the layer offsets are provided as a difference between an IMM timestamp and a VMM timestamp for a respective layer, the layer offsets may be determined using other techniques such as, but not limited to, phase-locked loop modeling. The offset of the one or more layers may provide insight into potential latency changes occurring at the hardware level at the AV 100.

$$AVMOffsetTrnprtLay = ( IMMTransLayTS - VMMTransLayTS \qquad Equation 5$$

$$AVMOffsetSecLay = IMMSecLayTS - VMMSecLayTS \qquad Equation 6$$

$$AVMOffsetRadLay = IMMRadLayTS - VMMRadLayTS \qquad Equation 7$$

The CMST model 134, 174 next determines the accuracy of the current automated vehicle time using a time accuracy validator (TAV) model that considers time data from different sources, including the time from the system clock of the AV (or AVM CS). In a non-limiting example, the inputs may include: GNSS time, system time, NTP/PTP time, IMM timestamp (e.g., application layer timestamp), and VMM timestamp (e.g., application layer timestamp). Accordingly, the TAV model may be represented by function 1 below.

$$avm\_time \_accuracy \_validator \_model ( gnss\_time , system\_time , ntp / ptp\_time , imm\_and \_vmm \_timestamp ) \qquad Function 1$$

The CMST model 134, 174 further computes a confidence of the current time in which the AV needs to operate versus operating in using a time confidence validator (TCV) model and various confidence values from other sources. In a non-limiting example, the TCV model is a function of a GNSS time confidence, a system time confidence, an NTP/PTP time confidence, a IMM timestamp confidence, and a VMM timestamp confidence. Accordingly, the TCV model may be represented by function 2 below.

$$avm\_time \_conf \_validator \_model ( gnss\_time \_confidence , system\_time \_confidence , ntp / ptp\_time \_confidence , imm\_and \_vmm \_timestamp \_confidence ) \qquad Function 2$$

The CMST model 134, 174 further computes a drift in the overall time by monitoring the different time sources to provide better control-trajectory-time basis operation. In a non-limiting example, the CMST model 134, 174 employs a time drift monitor (TDM) model that monitors the following time sources: GNSS time, system time, NTP/PTP time, IMM time sync, and VMM time sync. In TDM, the IMM time sync and the VMM time sync are provided by equations 1 to 7. Accordingly, the TDM model may be represented by function 3 below.

$$avm\_time \_drift \_monitor \_model ( gnss\_time , system\_time , ntp / ptp\_time , imm\_and \_vmm \_message \_timesync ) \qquad Function 3$$

The CMST model 134, 174 further computes the overall timestamp, as provided in equation 8, that is to be adjusted using a time drift adjuster (TDA) model. The TDA model uses outputs of the TAV model, the TCV model, and TDM model to determine a time drift estimate (e.g., “avm_time_drift_monitor_output”) and corrects the current timestamp (e.g., “current_avm_vehicle_time”) and adjusts confidence of the system time of the AV, where the adjusted system time is provided as “avm_time_drift_adjuster” in equation 8.

$$avm\_time \_drift \_adjuster = current\_avm \_vehicle \_time + \text{} / - avm\_time \_drift \_monitor \_output \qquad Equation 8$$

In some implementations, the CMST Model 134, 174 determines if a drift is obtained at operation 304C. For example, if the drift determined at 304B is zero, then no adjustment is needed. However, if a drift is greater than zero or less than zero, then the system time of the AV is changed/adjusted, at operation 306. If the CMST model 134 of the AVM CS 106 determines the drift, the AVM CS 106 may transmit a command to the AV 100 to have the AV 100 adjust its system time. If the CMST 174 of the AV 100 determines the drift, the AV clock sync module 172 directly adjusts the AV internal clock 170 (e.g., system clock).

Once the timestamp is adjusted, the time of the system clock is used by various modules of the AVM CS 106 and the AV 100 to marshal the AVs 100, at 306. In a non-limiting example, the AV 100 uses the time as a timestamp for messages transmitted to external systems (e.g., V2X messages) and/or to AVM features for marshalling the AV 100 in the facility 102.

In a non-limiting example, the TAV model, the TCV model, the TDM model, and/or the TDA model are defined using dynamic neural network training, rolling average of computed time & time-confidence, and/or recursive weighted least squares approach.

In determining the is directly tied into the hardware being used. The other time offset is directed more to latency of the communication protocols being used.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

In this application, the term “controller” and/or “module” (e.g., CS clock sync module 132 having CMST model 134, vision module 113, modules 124, 126, 128, 129 of communication system 120, drive controller 154 having AV module 169, AV clock sync module 172 having CMST model 174, and/or modules 160, 162, 164, 166 of the communication system 150) may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above (e.g., (e.g., CS clock sync module 132 having CMST model 134, vision module 113, modules 124, 126, 128, 129 of communication system 120, drive controller 154 having AV module 169, AV clock sync module 172 having CMST model 174, and/or modules 160, 162, 164, 166 of the communication system 150)) serve as software specifications, which can be translated into the computer programs by the routine work of a skilled technician or programmer.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for synchronizing time between a central server and an automated vehicle (AV), comprising:
obtaining a plurality of time inputs employable to synchronize clock of the AV;
exchanging a series of time synchronization (TS) messages, each TS message defined by a plurality of layers including at least two of an application layer, a transport layer, a security layer, or radio link layer;
generating a set of time offsets between a pair of TS messages among the series of TS messages, the set of time offsets defined for at least one layer among the plurality of layers for the pair of TS messages;
changing a system time of the AV using a time drift estimate defined by a set of time assessment models being a function of at least one the plurality of time inputs and the set of layer time offset values; and
controlling the AV using the system time and one or more marshalling instructions providing drive commands from the central server.

2. The method of claim 1, wherein each of the plurality of layers includes a timestamp confidence of a timestamp associated with the layer.

3. The method of claim 1, wherein the plurality of time inputs is obtained using at least one of an internal computer clock of the AV, an internal computer clock of the central server, a network time protocol, a precision time protocol, a global navigation satellite system, one or more timestamps of a marshalling message transmitted by at least one of the AV or the central server.

4. The method of claim 1, further comprising generating, using information from the series of TS messages, at least one of an over-the-air (OTA) request time offset, OTA response time offset, a central server processing time, or an AV message roundtrip trip time.

5. The method of claim 1, wherein the set of time assessment models includes at least one of:
a time accuracy validator model configured to determine an accuracy of a current time used by at least one of the AV or the central server,
a time confident validator model configured to determine a confidence of the time in which the AV is to employ versus a time being used using one or more confidence input received from the plurality of time inputs, or
a time drift monitor model configured to track a time drift of overall time.

6. The method of claim 5, wherein the set of time assessment models includes a time drift adjuster configured to determine the time drift estimate using outputs of the at least one of the time accuracy validator model, the time confident validator model, or the time drift monitor model.

7. The method of claim 1, further comprising:
transmitting, by the AV, a time synchronization request to the central server, the series of TS messages including the time synchronization request; and
calculating, by the AV in response to receiving a response to the time synchronization from the central server, a round trip time offset using a timestamp of the time synchronization request and a timestamp associated with response, the set of time offsets including the round trip time offset.

8. A vehicle system for an autonomous vehicle (AV) being marshalled in by a central server, the vehicle system comprising:
one or more computing devices configured to:
obtain a plurality of time inputs employable to synchronize the AV with the central server,
exchange a series of time synchronization (TS) messages with the central server, each TS message defined by a plurality of layers including at least two of an application layer, a transport layer, a security layer, or radio link layer,
generate a set of time offsets between a pair of TS messages among the series of TS messages, the set of time offsets defined for at least one layer among the plurality of layers for the pair of TS messages,
change a system time of the AV using a time drift estimate defined by a set of time assessment models being a function of at least one the plurality of time inputs and the set of layer time offset values, and
control the AV to perform a drive command using the system time in response to receiving a marshalling message having the drive command from the central server.

9. The system of claim 8, wherein the plurality of time inputs is obtained using at least one of an internal computer clock of the AV, an internal computer clock of the central server, a network time protocol, a precision time protocol, a global navigation satellite system, one or more timestamps of a marshalling message transmitted by at least one of the AV or the central server,

10. The system of claim 8, wherein the one or more computing devices is further configured to generate, using information from the series of TS messages, at least one of an over-the-air (OTA) request time offset, OTA response time offset, a central server processing time, or an AV message roundtrip trip time.

11. The system of claim 8, wherein the set of time assessment models includes at least one of:
a time accuracy validator model configured to determine an accuracy of a current time used by at least one of the AV or the central server,
a time confident validator model configured to determine a confidence of the time in which the AV is to employ versus a time being used using one or more confidence input received from the plurality of time inputs, or
a time drift monitor model configured to track a time drift of overall time.

12. The system of claim 11, wherein the set of time assessment models includes a time drift adjuster configured to determine the time drift estimate using outputs of the at least one of the time accuracy validator model, the time confident validator model, or the time drift monitor model.

13. The system of claim 8, wherein the one or more computing devices is further configured to:
transmit a time synchronization request to the central server, the series of TS messages including the time synchronization request; and
calculate, in response to receiving a response to the time synchronization from the central server, a round trip time offset using a timestamp of the time synchronization request and a timestamp associated with response, the set of time offsets including the round trip time offset.

14. A system for autonomously controlling an autonomous vehicle (AV), comprising:
an infrastructure server associated with a facility and including one or more computing devices configured to:
obtain a plurality of time inputs employable to synchronize the AV with the infrastructure server,
exchange a series of time synchronization (TS) messages with the AV, each TS message defined by a plurality of layers including at least two of an application layer, a transport layer, a security layer, or radio link layer,
generate a set of time offsets between a pair of TS messages among the series of TS messages, the set of time offsets defined for at least one layer among the plurality of layers for the pair of TS messages,
transmit a messaging including a command to change a system of the AV to an updated system time that is determined using a time drift estimate calculated using a set of time assessment models that are a function of at least one the plurality of time inputs and the set of layer time offset values, and
transmit one or more marshalling instructions having one or more drive commands to the AV to control movement of the AV based on the updated system time.

15. The system of claim 14, wherein the plurality of time inputs is obtained using at least one of an internal computer clock of the AV, an internal computer clock of the infrastructure server, a network time protocol, a precision time protocol, a global navigation satellite system, one or more timestamps of a marshalling message transmitted by at least one of the AV or the infrastructure server.

16. The system of claim 14, wherein the one or more computing devices is further configured to generate, using information from the series of TS messages, at least one of an over-the-air (OTA) request time offset, OTA response time offset, a central server processing time, or an AV message roundtrip trip time.

17. The system of claim 14, wherein the set of time assessment models includes at least one of:
a time accuracy validator model configured to determine an accuracy of a current time used by at least one of the AV or the infrastructure server,
a time confident validator model configured to determine a confidence of the time in which the AV is to employ versus a time being used using one or more confidence input received from the plurality of time inputs, or
a time drift monitor model configured to track a time drift of overall time.

18. The system of claim 17, wherein the set of time assessment models includes a time drift adjuster configured to determine the time drift estimate using outputs of the at least one of the time accuracy validator model, the time confident validator model, or the time drift monitor model.
